(19) United States
(12) Patent Application Publication
(10) Pub. No.: US 2018/0282531 A1
(43) Pub. Date: Oct. 4, 2018

(54) RUBBER COMPOSITION

(71) Applicant: COMPAGNIE GENERALE DES ETABLISSEMENTS MICHELIN, Clermont-Ferrand (FR)

(72) Inventors: Cecile BELIN, Clermont-Ferrand Cedex 9 (FR); Olivier GONCALVES, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 15/568,864

(22) PCT Filed: May 4, 2016
(86) PCT No.: PCT/EP2016/059953

§ 371 Date: Oct. 24, 2017

(30) Foreign Application Priority Data
May 11, 2015 (FR) 1554196

(51) Int. Cl. C08L 7/00; B60C 1/00; C08J 3/22

(52) U.S. Cl. CPC C08L 7/00; B60C 1/0016; C08J 2409/06; C08J 2307/00; C08J 3/226

(57) ABSTRACT

A rubber composition is provided. The rubber composition is based at least on an elastomer matrix comprising natural rubber and a functional diene elastomer, the functional diene elastomer bearing an SiOR function, R being hydrogen or a carbon-based group, the carbon black having a BET specific surface area of greater than 130 m²/g, the dispersion of the carbon black in the elastomer matrix having a Z value of greater than 80. The composition has an improved compromise between the hysteresis properties and the properties at break.

This application is a 371 national phase entry of PCT/EP2016/059953, filed on 4 May 2016, which claims benefit of French Patent Application No. 1554196, filed 11 May 2015, the entire contents of which are incorporated herein by reference for all purposes.

### BACKGROUND

### 1. Technical Field

The invention relates to a rubber composition based on natural rubber and on a reinforcing filler comprising a mixture of very fine carbon black and of silica, in particular for a tire tread, and more particularly for a tire intended to be fitted to vehicles that bear heavy loads and run on off-road surfaces.

### 2. Related Art

The tires intended to be fitted to vehicles that bear heavy loads and run on off-road surfaces are those for example that are fitted to vehicles that manoeuvre in mines and building sites. The treads of such tires are particularly sensitive to attacks due to the non-bituminous nature of the running surface. The rubber compositions that have good properties at break are perfectly suitable for forming the treads of such tires. The rubber compositions suitable for the mentioned use are for example those based on natural rubber and on a reinforcing filler comprising a mixture of very fine carbon black and of silica.

Furthermore, it is preferable that the rubber compositions reinforced by a mixture of very fine carbon black and of silica have the lowest possible hysteresis with a view to minimizing the overheating of the tire, which is particularly true for the tires that bear heavy loads and run on off-road surfaces. Specifically, the weight borne by the tire and the aggressive nature of the running surface make the tire sensitive to increases in temperature. The known property of a silanol or organooxysilane, in particular alkoxysilane functional elastomer, to reduce the hysteresis of a rubber composition reinforced by a silica, leads to the use of silanol or organooxysilane functional elastomers in rubber compositions based on natural rubber and on a reinforcing filler comprising a mixture of very fine carbon black and of silica being envisaged.

However it has been observed that the use of these functional elastomers in rubber compositions based on natural rubber and on a reinforcing filler comprising a very fine carbon black and a silica is accompanied by a reduction in their properties at break.

### SUMMARY

To improve the compromise between the properties at break and the hysteresis properties of rubber compositions based on natural rubber and on a reinforcing filler comprising carbon black and silica, it has been found that the addition of a silanol or organooxysilane functional elastomer to a rubber composition in which the carbon black has a high level of dispersion makes it possible to achieve an improved compromise between the properties at break and the hysteresis properties of the rubber composition.

Thus, a first subject of the invention relates to a rubber composition based at least on an elastomer matrix comprising natural rubber and a functional diene elastomer, on a reinforcing filler comprising a carbon black and a silica, on a coupling agent for binding the silica to the elastomer matrix and on a crosslinking system,
the functional diene elastomer being a diene elastomer that bears an SiOR function, R being hydrogen or a carbon-based group,
the carbon black having a BET specific surface area of greater than 130 m²/g,
the dispersion of the carbon black in the elastomer matrix having a Z value of greater than 80.

Another subject of the invention relates to a process for preparing the rubber composition in accordance with the invention, which process comprises the following steps:
a. a first masterbatch comprising the natural rubber and the carbon black dispersed with a Z value greater than or equal to 90 is prepared,
b. the silica and the functional diene elastomer, optionally in the form of a second masterbatch, are added to the first masterbatch,
c. the combined product is mixed by thermomechanical kneading.

The invention also relates to a tire tread which comprises a rubber composition in accordance with the invention, and also to a tire which comprises a rubber composition in accordance with the invention, preferably in its tread.

### I. DETAILED DESCRIPTION

In the present description, unless expressly indicated otherwise, all the percentages (%) shown are % by weight. The abbreviation “phr” means parts by weight per hundred parts of elastomer (of the total of the elastomers, if several elastomers are present).

Furthermore, any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

The expression “composition based on” should be understood as meaning, in the present description, a composition comprising the mixture and/or the in situ reaction product of the various constituents used, some of these base constituents (for example the elastomer, the filler or other additive conventionally used in a rubber composition intended for the manufacture of tires) being capable of reacting or intended to react with one another, at least in part, during the various phases of manufacture of the composition intended for the manufacture of tires.

“Elastomer matrix” is understood to mean all the elastomers of the rubber composition.

“Carbon-based group” is understood to mean a radical that contains carbon, such as a hydrocarbon-based group or a group containing carbon, hydrogen and at least one heteroatom.

The term “masterbatch” is understood to mean, in that which follows: an elastomer-based composite into which a filler and optionally other additives have been introduced.

An essential feature of the rubber composition according to embodiments of the invention is that of comprising a functional diene elastomer in addition to the natural rubber.

A diene elastomer (or equally “rubber”, the two terms being considered to be synonymous) should be understood, in a known way, to mean an (one or more is understood) elastomer resulting at least in part (i.e., a homopolymer or a copolymer) from diene monomers (monomers bearing two carbon-carbon double bonds which may or may not be conjugated).

These diene elastomers can be classified into two categories: “essentially unsaturated” or “essentially saturated”. “Essentially unsaturated” is generally understood to mean a diene elastomer resulting at least in part from conjugated diene monomers having a content of units of diene origin (conjugated dienes) which is greater than 15% (mol %); thus, diene elastomers such as butyl rubbers or copolymers of dienes and of α-olefins of EPDM type do not come within the preceding definition and can especially be described as “essentially saturated” diene elastomers (low or very low content, always less than 15%, of units of diene origin). In the category of “essentially unsaturated” diene elastomers, “highly unsaturated” diene elastomer is understood in particular to mean a diene elastomer having a content of units of diene origin (conjugated dienes) which is greater than 50%.

Although it applies to any type of diene elastomer, those skilled in the art of tires will understand that the invention is preferably carried out with essentially unsaturated diene elastomers.

Given these definitions, the expression diene elastomer capable of being used in the compositions in accordance with embodiments of the invention is intended especially to mean:
(a)—any homopolymer obtained by polymerization of a conjugated diene monomer, preferably having from 4 to 12 carbon atoms;
(b)—any copolymer obtained by copolymerization of one or more conjugated dienes with one another or with one or more vinylaromatic compounds preferably having from 8 to 20 carbon atoms.

The following are especially suitable as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can contain between 99% and 20% by weight of diene units and between 1% and 80% by weight of vinylaromatic units.

More preferably, the diene elastomer is selected from the group consisting of polybutadienes (BRs) (especially those having a content of cis-1,4-bonds of greater than 90%), synthetic polyisoprenes (IRs), butadiene copolymers, in particular butadiene-styrene copolymers (SBRs), and blends of these elastomers.

Polybutadienes, and in particular those having a content (mol %) of 1, 2-units of between 4% and 80% or those having a content (mol %) of cis-1,4-of greater than 80%, polyisoprenes, butadiene/styrene copolymers and in particular those having a Tg (glass transition temperature, Tg, measured according to ASTM D3418) of between 0° C. and −70° C. and more particularly between −10° C. and −60° C., a styrene content of between 5% and 60% by weight and more particularly between 20% and 50%, a content (mol %) of 1, 2-bonds of the butadiene part of between 4% and 75% and a content (mol %) of trans-1,4-bonds of between 10% and 80%, are suitable.

Advantageously, the diene elastomer is a butadiene/styrene copolymer preferably having a glass transition temperature ranging from −65° C. to −20° C.

The diene elastomer of use for the purposes of embodiments of the invention, referred to as functional diene elastomer, is a diene elastomer that bears a (i.e. one or more) SiOR function, R being hydrogen or a carbon-based group.

Generally, a function borne by an elastomer may be located on the elastomer chain according to one of three possible configurations: along the elastomer chain as a pendent group apart from at the ends of the elastomer chain, at one end of the elastomer chain or else within the actual elastomer chain (i.e. not at the ends), i.e. it is the joining point of at least two branches of the elastomer. The latter case occurs especially in the case where the elastomer is functionalized by the use of a coupling or star-branching agent which provides the function in question.

In particular, the SiOR function may be located along the elastomer chain as a pendent group, at one end of the elastomer chain or else within the actual elastomer chain. In the case where there are several SiOR functions borne by the elastomer, they may occupy one or other of the above configurations.

The functional diene elastomer may be a linear or star-branched, or even branched polymer. If it is a linear polymer, it may or may not be coupled. This elastomer may have a monomodal, bimodal or polymodal molecular distribution.

According to another preferred embodiment of the invention, the functional diene elastomer is predominantly in a linear form, that is to say that if it comprises star-branched or branched chains, these represent a minority weight fraction in this elastomer.

According to one particularly preferred embodiment of the invention, the diene elastomer bears one (i.e. one or more) function, referred to as a “silanol” function, of formula SiOH (R is hydrogen), preferably a single silanol function.

Diene elastomers corresponding to such a definition are well known, they have for example been described in documents EP 0 778 311 B1, WO 2008/141702, WO 2006/050486, EP 0 877 047 B1 or EP 1 400 559 B1. The silanol function SiOH is preferably located at the end of the elastomer chain, in particular in the form of a dimethylsilanol group —SiMe₂SiOH.

According to another embodiment of the invention, the functional diene elastomer bears at least one (i.e. one or more) function of formula SiOR in which R is a C₁ or C₆ hydrocarbon-based radical (i.e. containing from 1 to 6 carbon atoms), preferably methyl or ethyl.

Diene elastomers corresponding to such a definition are also well known, they have for example been described in documents JP 63-215701, JP 62-227908, U.S. Pat. No. 5,409,969 or WO 2006/050486.

The functional diene elastomer may bear another (i.e. one or more) function which is different from the SiOR function. This other function may be selected from the group consisting of epoxy and amine functions, it being possible for the amine to be a primary, secondary or tertiary amine.

The amine function may be located on the same end (or the same ends) of the elastomer chain as the SiOR function. Elastomers having an SiOR function and an amine function on the same end of the elastomer chain have been described for example in the patents or patent applications EP 1 457 501 B1, WO 2006/076629, EP 0 341 496 B1 or WO 2009/133068 or else in WO 2004/111094.

The amine function may be present on an end of the elastomer chain that does not bear the SiOR function. Such a configuration may be produced for example by the use of an initiator bearing an amine function, in particular by the use of an initiator that is a lithium amide, such as lithium pyrrolidide or lithium hexamethyleneimide, or an organolithium compound bearing an amine function such as dimethylaminopropyllithium and 3-pyrrolidinopropyllithium. Such initiators have been described for example in patents EP 0 590 490 B1 and EP 0 626 278 B1. Such elastomers bearing an SiOR function and an amine function at their different chain ends have for example been described in patents EP 0 778 311 B1 and U.S. Pat. No. 5,508,333.

Elastomers bearing both an SiOR function and an epoxy function have for example been described in patents EP 0 890 607 B1 and EP 0 692 492 B1. Elastomers bearing both an SiOR function and a tin function have for example been described in patent EP 1 000 970 B1.

It is understood that the functional diene elastomer may be formed by a mixture of elastomers that differ from one another by the chemical nature of the SiOR function, by its position on the elastomer chain, by the presence of an additional function other than SiOR, by their microstructure or else by their macrostructure.

According to another preferred embodiment of the invention, the content of functional diene elastomer in the rubber composition is within a range extending from 15 to 45 phr, the content of natural rubber being from 55 to 85 phr.

The rubber composition may comprise an additional diene elastomer. This optional additional diene elastomer is different from the functional diene elastomer in so far as it bears no SiOR function. Nevertheless, this additional diene elastomer may have a microstructure or a macrostructure that may be identical to or different from those of the functional diene elastomer. It is then used in a proportion ranging from 0 to 25 phr.

When the functional diene elastomer bears a silanol function at the chain end, in particular a single silanol function, the rubber composition may comprise an additional elastomer that is coupled or star-branched to the tin. By definition, this additional elastomer is different from the functional diene elastomer in so far as it bears no SiOR function. Nevertheless, it may have a microstructure that may be identical to or different from those of the functional diene elastomer. It is used for example in a proportion ranging from 0 to 25 phr.

“Reinforcing filler” is intended to mean particles with a (weight-)average size of less than a micrometre, generally less than 500 nm, most often between 20 and 200 nm, in particular and more preferentially between 20 and 150 nm.

The reinforcing filler of use for the requirements of embodiments of the invention comprises a carbon black having a BET specific surface area of greater than 130 m²/g. The BET specific surface area of the carbon blacks is measured according to Standard D6556-10 [multipoint (at least 5 points) method—gas: nitrogen—p/p0 relative pressure range: 0.01 to 0.5].

Mention may be made, as carbon black, of the reinforcing blacks of the ASTM grade 100 series, in particular the blacks N115, N134, and finer blacks such as CRX1507.

The carbon black can be used on its own, as available commercially, or in any other form, for example as support for some of the rubber additives used.

The silica used may be any silica known to those skilled in the art, capable of reinforcing, by itself alone, without means other than an intermediate coupling agent, a rubber composition intended for the manufacture of pneumatic tires; in other words able to replace, in its reinforcing role, a conventional tire-grade carbon black.

The silica used may be a precipitated or fumed silica having a BET surface area and a CTAB specific surface area both of less than 450 m²/g, preferably from 30 to 400 m²/g, especially between 60 and 300 m²/g. Mention may be made, as example of silica of use for the requirements of embodiments of the invention, of the Ultrasil VN3 silica sold by Evonik. As highly dispersible precipitated silicas (“HDSs”), mention will be made, for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber and the silicas having a high specific surface area as described in application WO 03/016387.

To further optimize the hysteresis properties while maintaining an improved compromise between the properties at break and hysteresis, the silica has a BET surface area ranging preferably from 80 to 200 m²/g, preferentially from 100 to 180 m²/g. These preferential BET surface area ranges apply to any one of the embodiments of the invention.

In the present account, as regards the silica, the BET specific surface area is determined in a known way by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method—gas: nitrogen—degassing: 1 hour at 160° C.—p/p0 relative pressure range: 0.05 to 0.17). The CTAB specific surface area is the external surface area determined according to French Standard NF T 45-007 of November 1987 (method B).

The physical state in which the silica is present is of no concern, whether it is in the form of powder, micropearls, granules or else beads. Of course, “silica” is also intended to mean mixtures of various silicas.

To make the silica reinforcing in a composition of diene rubber, it is known practice to use a coupling agent to couple the silica to the diene elastomer. The at least bifunctional coupling agent (or bonding agent), which is most often a silane, makes it possible to provide a satisfactory chemical and/or physical connection between the inorganic filler (surface of its particles) and the diene elastomer. Use is made in particular of at least bifunctional organosilanes or polyorganosiloxanes.

As coupling agent, use is made especially of silane polysulfides, referred to as “symmetrical” or “asymmetrical” depending on their specific structure, such as described, for example, in applications WO 03/002648 (or US 2005/016651) and WO 03/002649 (or US 2005/016650).

Particularly suitable, without the definition below being limiting, are silane polysulfides corresponding to the general formula (V):

Z—A—Sₓ-A-Z (V)
in which:
   x is an integer from 2 to 8 (preferably from 2 to 5);
   the A symbols, which are identical or different, represent a divalent hydrocarbon-based radical (preferably a C₁-C₁₈ alkylene group or a C₆-C₁₂ arylene group, more particularly a C₁-C₁₀, especially C₁-C₄, alkylene, in particular propylene);
   the Z symbols, which are identical or different, correspond to one of the three formulae below:

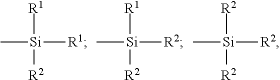

in which:
   the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
   the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferentially still a group chosen from C₁-C₄ alkoxyls, in particular methoxyl and ethoxyl).

In the case of a mixture of alkoxysilane polysulfides corresponding to the above formula (I), especially customary commercially available mixtures, the mean value of “x” is a fractional number preferably of between 2 and 5, more preferentially close to 4. However, embodiments of the invention can also advantageously be carried out, for example, with alkoxysilane disulfides (x=2).

Mention will more particularly be made, as examples of silane polysulfides, of bis((C₁-C₄)alkoxyl(C₁-C₄)alkylsilyl(C₁-C₄)alkyl) polysulfides (in particular disulfides, trisulfides or tetrasulfides), such as, for example, bis(3-trimethoxysilylpropyl) or bis(3-triethoxysilylpropyl) polysulfides. Use will in particular be made, among these compounds, of bis(3-triethoxysilylpropyl) tetrasulfide, abbreviated to TESPT, of formula [(C₂H₅O)₃Si(CH₂)₃S₂]₂, or of bis(triethoxysilylpropyl) disulfide, abbreviated to TESPD, of formula [(C₂H₅O)₃Si(CH₂)₃S]₂.

As coupling agent other than alkoxysilane polysulfide, mention will especially be made of bifunctional POSs (polyorganosiloxanes), or else of hydroxysilane polysulfides, such as described in patent applications WO 02/30939 (or U.S. Pat. No. 6,774,255) and WO 02/31041 (or US 2004/051210), or else of silanes or POSs bearing azodicarbonyl functional groups, such as described, for example, in patent applications WO 2006/125532, WO 2006/125533 and WO 2006/125534.

According to any one of the embodiments of the invention, the coupling agent is preferably a silane polysulfide.

The content of carbon black is preferably from 5 to 25 phr, more preferentially from 15 to 25 phr. The content of silica used is preferably from 10 to 30 phr, more preferentially 15 to 25 phr. The content of reinforcing filler is preferably from 30 to 55 phr, more preferentially 35 to 50 phr. These preferential ranges of carbon black, silica and reinforcing filler may apply to any one of the embodiments of the invention. They are particularly suitable when the rubber composition is intended to be used in a tread for a tire intended to be fitted on vehicles bearing heavy loads and running on off-road surfaces.

Typically, the content of coupling agent represents from 0.5% to 15% by weight relative to the amount of inorganic filler. Its content is preferentially between 5 and 15 wt %, more preferentially within a range extending from 5 to 10 wt %. This content is easily adjusted by those skilled in the art depending on the content of silica used in the composition.

The crosslinking system may be based on sulfur, sulfur donors, peroxide, bismaleimides or mixtures thereof.

According to any one of the embodiments of the invention, the crosslinking system is preferentially a vulcanization system, that is to say a system based on sulfur (or on a sulfur donor agent) and on a primary vulcanization accelerator. Various known secondary vulcanization accelerators or vulcanization activators, such as zinc oxide, stearic acid or equivalent compounds, or guanidine derivatives such as an N,N′-disubstituted guanidine (in particular diphenylguanidine), or else known vulcanization retarders, may be added to this base vulcanization system, being incorporated during the first non-productive phase and/or during the productive phase, as described subsequently.

When sulfur is used, it is used at a preferential content of between 0.5 and 12 phr, in particular between 1 and 10 phr. The primary vulcanization accelerator is used at a preferential content of between 0.5 and 10 phr, more preferentially of between 0.5 and 5.0 phr.

As (primary or secondary) accelerator, use may be made of any compound capable of acting as accelerator for the vulcanization of diene elastomers in the presence of sulfur, especially accelerators of the thiazole type, and also their derivatives, and accelerators of sulfenamide, thiuram, dithiocarbamate, dithiophosphate, thiourea and xanthate types. As examples of such accelerators, mention may especially be made of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzyl thiuram disulfide (TBZTD) zinc dibenzyldithiocarbamate (ZBEC) and the mixtures of these compounds.

The rubber composition in accordance with embodiments of the invention may also comprise all or some of the usual additives customarily used in rubber compositions intended to constitute mixtures of finished rubber articles such as tires, such as, for example, pigments, protective agents such as antiozone waxes, chemical antiozonants, antioxidants and antifatigue agents.

Use may be made, in the rubber composition defined according to any one of the embodiments of the invention, of processing aids capable, in a known manner, owing to an improvement in the dispersion of the silica in the elastomer matrix and to a lowering of the viscosity of the compositions, of improving their processability in the uncured state. These aids, also known as covering agents for the silica, are for example hydrolysable silanes such as alkylalkoxysilanes (in particular alkyltriethoxysilanes), polyols, polyethers (for example polyethylene glycols), primary, secondary or tertiary amines (for example trialkanolamines), hydroxylated or hydrolysable POSs, for example α,ω-dihydroxypolyorganosiloxanes (in particular α,ω-dihydroxypolydimethylsiloxanes), fatty acids, such as, for example, stearic acid, or guanidine derivatives, in particular an N,N′-disubstituted guanidine, such as N,N′-diphenylguanidine (DPG), also known as a secondary vulcanization accelerator. Any one of the covering agents for the silica mentioned above may be used, preferentially in a content ranging from 0 to 5 phr, more preferentially between 0 and 5 phr.

An essential feature of the rubber composition in accordance with embodiments of the invention is the level of dispersion of the carbon black. The dispersion of the carbon black in the elastomer matrix has a Z value of greater than 80. The Z value that characterizes the dispersion of the carbon black in the elastomer matrix is measured, after crosslinking of the elastomer matrix, according to the method described by S. Otto et al. in Kautschuk Gummi Kunststoffe, 58 Jahrgang, NR 7-8/2005, in agreement with Standard ISO 11345.

In a known way, the dispersion of filler in an elastomeric matrix can be represented by the Z value, which is measured, after crosslinking, according to the method described by S. Otto et al. in Kautschuk Gummi Kunststoffe, 58 Jahrgang, NR 7-8/2005, in agreement with Standard ISO 11345.

The calculation of the Z value is based on the percentage of surface area in which the filler is not dispersed (“% undispersed surface area”), as measured by the “disperGRADER+” device supplied, with its operating instructions and “disperDATA” operating software, by Dynisco, according to the equation:

Z=100−(% undispersed surface area)/0.35

The undispersed surface area percentage is, for its part, measured using a camera looking at the surface of the sample under incident light at 30°. The light points are associated with the filler and with agglomerates, while the dark points are associated with the elastomer matrix; digital processing converts the image into a black and white image and enables the percentage of undispersed surface area to be determined, as described by S. Otto in the abovementioned document.

The higher the Z value, the better the dispersion of the filler in the elastomer matrix (a Z value of 100 corresponding to a perfect dispersion and a Z value of 0 to a mediocre dispersion). A Z value of greater than 80 will be deemed to correspond to a surface area having very good dispersion of the filler in the elastomer matrix.

The rubber composition in accordance with embodiments of the invention may be prepared according to the process described below, which is another subject of the invention.

The process has the essential feature of comprising the following steps:
a. a first masterbatch comprising the natural rubber and the carbon black dispersed with a Z value greater than or equal to 90 is prepared,
b. the silica and the functional diene elastomer are added to the first masterbatch,
c. the combined product is mixed by thermomechanical kneading.

The first masterbatch is preferably prepared by liquid-phase mixing starting from a natural rubber latex and an aqueous dispersion of carbon black, commonly referred to as a slurry. More preferentially, in order to prepare the first masterbatch, the steps of the process described in document U.S. Pat. No. 6,048,923 will be followed, which consists in particular in feeding a first continuous stream of a natural rubber latex to a mixing zone of a coagulation reactor defining an elongated coagulation zone extending between the mixing zone and an outlet, in feeding the mixing zone of the coagulation reactor with a second continuous stream of a fluid comprising carbon black under pressure in order to form a mixture with the natural rubber latex by mixing the first stream and the second stream in the mixing zone sufficiently energetically to coagulate the natural rubber latex with the carbon black prior to the outlet, said mixture flowing as a continuous stream towards the outlet zone and said filler being capable of coagulating the elastomer latex, in recovering the coagulum obtained previously at the outlet of the reactor in the form of a continuous stream and drying it in order to recover the masterbatch.

Natural rubber (NR) latex exists in various forms, as explained in detail in Chapter 3, “Latex concentrates: properties and composition”, by K. F. Gaseley, A. D. T. Gordon and T. D. Pendle in “Natural Rubber Science and Technology”, A. D. Roberts, Oxford University Press—1988. In particular, several forms of natural rubber latex are sold: the natural rubber latices referred to as “field latices”, the natural rubber latices referred to as “concentrated natural rubber latices”, epoxidized latices (ENRs), deproteinized latices or else prevulcanized latices. Natural rubber field latex is a latex to which ammonia has been added in order to prevent premature coagulation and concentrated natural rubber latex corresponds to a field latex which has undergone a treatment corresponding to a washing, followed by a further concentration. The various categories of concentrated natural rubber latices are listed in particular according to standard ASTM D 1076-06. Singled out in particular among these concentrated natural rubber latices are the concentrated natural rubber latices of the grade referred to as: “HA” (high ammonia) and of the grade referred to as “LA” (low ammonia); for embodiments of the invention, use will advantageously be made of concentrated natural rubber latices of HA grade.

According to one particular embodiment of the invention, the silica and the functional diene elastomer are added to the first masterbatch by also being provided in the form of a second masterbatch which will have been prepared beforehand. The second masterbatch may be prepared in solid form, in particular by thermomechanical kneading of the functional diene elastomer and the silica, in particular until a maximum temperature between 140° C. et 180° C. is achieved. The second masterbatch is mixed with the first masterbatch by thermomechanical kneading.

According to this particular embodiment, the second masterbatch containing the functional diene elastomer and the silica preferably also comprises the coupling agent, such as a silane polysulfide, and optionally a covering agent for the silica.

It should be noted in particular that the incorporation of the functional diene elastomer alone and the silica alone or in the form of a second masterbatch may be performed simultaneously with the introduction into the mixer of the other constituents (in particular the first masterbatch) but also advantageously that this or these incorporations may be offset in time by a few tens of seconds to a few minutes. In the case of introduction of the functional diene elastomer alone and the silica alone, offset in time by a few tens of seconds to a few minutes, the silica can be introduced before, after or simultaneously with the functional diene elastomer.

The rubber composition may be manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second phase of mechanical working (sometimes referred to as a “productive” phase) at lower temperature, typically below 120° C., for example between 60° C. and 100° C., during which finishing phase the crosslinking system is incorporated. During the first “non-productive” phase, the functional diene elastomer and the silica are added to the first masterbatch by kneading thermomechanically until a maximum temperature of between 130° C. and 200° C. is reached. The “non-productive” phase, is usually followed by cooling to a temperature below 100° C., before starting the second phase in which the crosslinking system is incorporated and the combined mixture is kneaded up to a maximum temperature below 120° C.

According to one embodiment of the invention, the first masterbatch, the functional elastomer and the silica, where appropriate in the form of a second mixture, and also the other ingredients of the rubber composition with the exception of the crosslinking system, are incorporated intimately, by kneading, during the first “non-productive” phase, that is to say at least these various base constituents are introduced into the mixer and thermomechanically kneaded, in one or more steps, until the maximum temperature of between 130° C. and 200° C., preferably between 145° C. and 185° C., is reached.

By way of example, the first (non-productive) phase is performed in a single thermomechanical step during which all the necessary constituents (where appropriate in the form of masterbatches as specified above), the optional complementary covering agents or processing aids and various other additives, with the exception of the crosslinking system, are introduced into an appropriate mixer, such as a standard internal mixer. The total duration of the kneading, in this non-productive phase, is preferably between 1 and 15 min. After cooling the mixture thus obtained during the first non-productive phase, the crosslinking system is then incorporated at low temperature, generally in an external mixer, such as an open mill; everything is then mixed (productive phase) for a few minutes, for example between 2 and 15 min.

The final composition thus obtained is subsequently calendered, for example in the form of a sheet or a slab, especially for laboratory characterization, or else extruded in the form of a rubber profiled element which can be used, for example, as a tire tread.

Thus, according to a specific embodiment of the invention, the rubber composition in accordance with the invention, which can either be in the uncured state (before vulcanization) or in the cured state (after vulcanization), is in a tire, in particular in a tire tread.

The abovementioned characteristics of embodiments of the present invention, and also others, will be better understood on reading the following description of several exemplary embodiments of the invention, given by way of illustration and without limitation.

### II. EXEMPLARY EMBODIMENTS

### II.1—Measurements and Tests Used:

### II.1.1—Properties at Break:

The tests make it possible to determine the elasticity stresses and the properties at break; those carried out on cured mixtures are carried out in accordance with standard AFNOR-NF-T46-002 of September 1988.

At a temperature of 60° C.-2° C., and under standard hygrometry conditions (50-5% relative humidity), according to French standard NF T 40-101 (December 1979), the tensile strengths (in MPa) and the elongations at break (in %) are measured, the energy at break (breaking energy) being the product of the tensile strength and the elongation at break.

### II.1.2—Dynamic Properties:

The dynamic property tan(d)max is measured on a viscosity analyser (Metravib VA4000), according to standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz and at a temperature of 100° C., according to standard ASTM D 1349-99, is recorded. A strain amplitude sweep is carried out from 0.1% to 50% (outward cycle) and then from 50% to 0.1% (return cycle). The result made use of is the loss factor (tan d). The maximum value of tan d observed (tan(d)max) between the values at 0.1% and at 50% strain (Payne effect) is shown for the return cycle.

### II.2—Preparation of the Rubber Compositions:

This section relates to the preparation of the compositions T1, T2, T3, T1-F, M2 and M3 for illustrating embodiments of the invention, and also to the preparation of the masterbatches used in the preparation of these same rubber compositions T2, T3, M2 and M3.

Independently of their production process, the formulation of all the rubber compositions T1, T2, T3, T1-F, M2 and M3 is the following:
NR: 55 phr
SBR: 45 phr
Carbon black: 20 phr
Silica: 25 phr
Silane: 1.9 phr
DPG: 0.3 phr
Antioxidant: 2.5 phr
Antiozone wax: 1 phr
Stearic acid: 2.5 phr
ZnO: 2.7 phr
CBS 1.4 phr
Sulfur: 1 phr.

### II.2.1—Preparation of the Masterbatch of Natural Rubber and Carbon Black (MB-NR):

The masterbatch of natural rubber and carbon black (MB-NR) used in the compositions T2, T3, M2 and M3 is produced in the liquid phase according to the process described in U.S. Pat. No. 6,048,923.

Thus, the masterbatch is prepared, according to the protocol explained in detail in the aforementioned patent, from carbon black N134 sold by Cabot Corporation, and natural rubber field latex originating from Malaysia and having a rubber solids content of 28% and an ammonia content of 0.3%.

The masterbatch MB-NR of natural rubber and carbon black is thus obtained in which the content of carbon black is 50 phr.

| Masterbatch | MB-NR |
|---|---|
| NR | 100 |
| N134 | 50 |

### II.2.2—Preparation of the Masterbatches of Diene Elastomer and of Silica (MB-SBR1 and MB-SBR2):

The masterbatches of SBR and of silica (MB-SBR) contain not only the diene elastomer and the silica, but also the silane and the DPG, in the contents indicated below in phr. The silica and the silane are the same as those used in the other rubber compositions T1, T3, T1-F and M3. The silica is a silica with a BET of 120 m²/g, the coupling agent is the “Si69” TESPT silane, the secondary accelerator is diphenylguanidine (DPG).

| Masterbatch | MB-SBR |
|---|---|
| SBR | 100 |
| Silica | 45 |
| Silane | 3.4 |
| DPG | 0.6 |

The contents of silica, silane and DPG in the MB-SBR masterbatches are adjusted so that their contents in the rubber compositions T2 and M2 containing natural rubber, carbon black and MB-SBR masterbatch are identical to the other rubber compositions T1, T3, T1-F and M3.

The MB-SBR masterbatches differ from one another by the presence or absence of a function on the SBR diene elastomer: the diene elastomer used in the MB-SBR1 masterbatch is a non-functional SBR (SBR1), the diene elastomer used in the MB-SBR2 masterbatch is a functional SBR in which more than 70% of the chains bear a silanol function at the chain end (SBR2). The MB-SBR1 masterbatch is used in the composition T2, the MB-SBR2 masterbatch in the composition M2.

The MB-SBR masterbatches are prepared in a mixer, filled to 70% and the initial vessel temperature of which is around 90° C., by incorporating the silica, the silane and the DPG into the diene elastomer by thermomechanical kneading until a maximum “dropping” temperature of between 140 and 180° C. is reached.

### II.2.3—Preparation of the Rubber Compositions T1, T2, T3, T1-F, M2 and M3:

The rubber compositions differ by the presence or absence of an SiOR function on the SBR diene elastomer, by their preparation process which may or may not involve the use of a masterbatch of natural rubber and carbon black and of a masterbatch of SBR and silica.

II.2.3.1—Preparation of the Rubber Compositions T1 and T1-F:

The rubber compositions T1 and T1-F are rubber compositions prepared in a conventional manner, since their preparation does not require the preparation of a masterbatch of natural rubber and carbon black. The composition T1-F differs from T1 in that the SBR contained in T1-F is an SBR in which more than 70% of the chains bear a silanol function at the chain end. The contents of natural rubber and of SBR in T1 and T1-F are indicated in phr below:

| Composition | T1 | T1-F |
|---|---|---|
| NR (1) | 55 | 55 |
| SBR1 (2) | 45 | — |
| SBR2 (3) | — | 45 |

(1) natural rubber;
(2) SBR with 26% of styrene and 24% of 1,2- units of the butadiene part;
(3) SBR with 26% of styrene units and 24% of 1,2- units of the butadiene part, in which more than 70% of the chains bear a silanol function at the end of the elastomer chain.

The natural rubber in solid form, the carbon black, the SBR, the silica, the silane, the DPG and the various other ingredients, with the exception of the vulcanization system, are introduced into an internal mixer which is 70% filled and which has an initial vessel temperature of approximately 90° C. Thermomechanical working (non-productive phase) is then performed in one step (total kneading time equal to about 5 min), until a maximum “dropping” temperature of about 165° C. is reached.

The mixture thus obtained is recovered and cooled and then the vulcanization system (sulfur and sulfenamide accelerator) is added on an external mixer (homofinisher) at 70° C., everything being mixed (productive phase) for approximately 5 to 6 min.

The compositions thus obtained are subsequently calendered, either in the form of slabs (thickness of 2 to 3 mm) or of thin sheets of rubber, for the measurement of their physical or mechanical properties, or in the form of profiled elements which can be used directly, after cutting and/or assembling to the desired dimensions, for example as semi-finished products for tires, in particular as tire treads.

II.2.3.2—Preparation of the Rubber Compositions T3 and M3:

The compositions T3 and M3 both contain a masterbatch of natural rubber and carbon black; they differ in that the SBR in M3 bears an SiOR function (R being H), which is not the case for the SBR in T3. The contents of natural rubber and of SBR alone (i.e. not in masterbatch form) and of masterbatches in T3 and M3 are indicated in phr below.

| Composition | T3 | M3 |
|---|---|---|
| NR (1) | 15 | 15 |
| SBR1 (2) | 45 | — |
| SBR2 (3) | — | 45 |
| MB-NR (4) | 60 | 60 |

(1) natural rubber;
(2) SBR with 26% of styrene and 24% of 1,2- units of the butadiene part;
(3) SBR with 26% of styrene units and 24% of 1,2- units of the butadiene part, of which more than 70% of the chains bear a silanol function at the end of the elastomer chain;
(4) masterbatch mentioned in section II.2.1

The same process as for the preparation of T1 and T1-F is followed apart from the fact that the natural rubber and the carbon black are introduced together in the form of the MB-NR masterbatch described in section II.2.1.

II.2.3.3—Preparation of the Rubber Compositions T2 and M2:

The compositions T2 and M2 both contain a masterbatch of natural rubber and carbon black (MB-NR) and a masterbatch of SBR and silica; they differ in that the SBR in M2 bears an SiOR function (R being H), which is not the case for the SBR in T2. The contents of natural rubber alone and of masterbatches in T2 and M2 are indicated in phr below.

| Composition | T2 | M2 |
|---|---|---|
| NR (1) | 15 | 15 |
| MB-NR (4) | 60 | 60 |
| MB-SBR1 (5) | 72 | |
| MB-SBR2 (6) | — | 72 |

(1) natural rubber;
(4) masterbatch mentioned in section II.2.1;
(5) and (6) masterbatches mentioned in section II.2.2.

The same process as for the preparation of T3 and M3 is followed apart from the fact that the SBR, the silica and the DPG are introduced together in the form of the masterbatch MB-SBR1 (for T2) or MB-SBR2 (for M2).

### II.3—Results:

The properties of the rubber compositions prepared appear in Table 1.

The rubber compositions T1, T2 and T3 are not in accordance with the invention for at least the following reason: they do not contain a functional diene elastomer bearing an SiOR function. The rubber composition T1-F comprising a functional diene elastomer bearing a silanol function is not in accordance with the invention, since the Z value is not greater than 80.

The compositions M2 and M3 are in accordance with embodiments of the invention: the diene elastomer bears a silanol function and the Z value is greater than 80.

TABLE 1

| Composition | T1 | T2 | T3 | T1-F | M2 | M3 |
|---|---|---|---|---|---|---|
| Z value | 74 | 86 | 84 | 54 | 86 | 83 |
| Energy at break | 104 | 98 | 85 | 61 | 94 | 84 |
| 60° C. (MJ) | | | | | | |
| Tand(max) | 0.078 | 0.079 | 0.086 | 0.066 | 0.063 | 0.073 |
| 100° C. | | | | | | |

It is observed that the rubber compositions M2 and M3 in accordance with embodiments of the invention have the best compromise of hysteresis and energy at break properties.

The compositions made from a masterbatch of natural rubber and carbon black all have a good dispersion of the carbon black, since the corresponding Z values are greater than 80.

Although the composition T1-F is the composition with the lowest hysteresis (tandof 0.066), it is also the one that has the worst properties at break (energy at break being only 61 J). The compositions T1, T2 and T3 for which the energy varies from 85 to 104 J are among those which have the best properties at break, but they also have the highest hysteresis (tandof at least 0.078).

The improvement in the compromise observed with the compositions M2 and M3 is clearly due to the coexistence in the rubber composition of a diene elastomer bearing an SiOR function and of a Z value of greater than 80. Indeed, no improvement in the compromise is observed in the case of the compositions T2 and T3 having a Z value of greater than 80 free of diene elastomers bearing an SiOR function. Quite the opposite, for these compositions T2 and T3 not only is a reduction in the properties at break observed, but also an increase in the hysteresis. Specifically, the energy at break values for T2 and T3 are respectively 98 and 85 versus 104 for T1, whereas the t and values are 0.079 for T2 and 0.086 for T3 versus 0.078 for T1. A good dispersion of the carbon black, in the absence of diene elastomer bearing an SiOR function, in a rubber composition reinforced by a silica and a carbon black, is insufficient to improve the compromise.

In summary, it has surprisingly been discovered that a rubber composition reinforced by a silica and a carbon black with a Z value of greater than 80 based on natural rubber and on a diene elastomer bearing an SiOR function made it possible to obtain the best compromise between the hysteresis properties and the properties at break.

1. A rubber composition based at least on an elastomer matrix comprising natural rubber and a functional diene elastomer, on a reinforcing filler comprising a carbon black and a silica, on a coupling agent for binding the silica to the elastomer matrix and on a crosslinking system,
the functional diene elastomer being a diene elastomer that bears an SiOR function, R being hydrogen or a carbon-based group,
the carbon black having a BET specific surface area of greater than 130 m²/g,
the dispersion of the carbon black in the elastomer matrix having a Z value of greater than 80.

2. A rubber composition according to claim 1, in which the contents of carbon black and of silica are respectively between 5 and 25 phr and between 10 and 30 phr.

3. A rubber composition according to claim 1, in which the content of reinforcing filler is between 30 and 55 phr.

4. A rubber composition according to claim 1, in which the diene elastomer is a styrene/butadiene copolymer.

5. A rubber composition according to claim 1, in which the functional diene elastomer bears a silanol function, preferably at the chain end, or SiOR function with R being methyl or ethyl.

6. A rubber composition according to claim 1, in which the content of natural rubber is from 55 to 85 phr and the content of functional diene elastomer is from 15 to 45 phr.

7. A rubber composition according to claim 1, in which the crosslinking system is a vulcanization system.

8. A rubber composition according to claim 1, which additionally comprises an agent for covering the silica.

9. A process for preparing a rubber composition defined according to claim 1, which comprises the following steps:
a. a first masterbatch comprising the natural rubber and the carbon black dispersed with a Z value greater than or equal to 90 is prepared,
b. the silica and the functional diene elastomer are added to the first masterbatch,
c. the combined mixture is mixed by thermomechanical kneading.

10. A process according to claim 9, in which the silica and the functional diene elastomer are added to the first masterbatch in the form of a second masterbatch.

11. A process according to claim 10, in which the second masterbatch additionally contains the coupling agent and optionally an agent for covering the silica.

12. A process according to claim 11, in which the content of covering agent is between 0 and 5 phr.

13. A process according to claim 10, in which the preparation of the second masterbatch is followed, before step c, by a thermomechanical kneading until a maximum temperature between 140° C. and 180° C. is reached.

14. A process according to claim 9, in which the first masterbatch is prepared by liquid-phase mixing starting from a natural rubber latex and an aqueous dispersion of carbon black.

15. A process according to claim 14, in which the first masterbatch is prepared according to the following steps:
a. a first continuous stream of a natural rubber latex is fed to a mixing zone of a coagulation reactor defining an elongated coagulation zone extending between the mixing zone and an outlet,
b. the mixing zone of the coagulation reactor is fed with a second continuous stream of a fluid comprising carbon black under pressure in order to form a mixture with the natural rubber latex by mixing the first stream and the second stream in the mixing zone sufficiently energetically to coagulate the natural rubber latex with the carbon black prior to the outlet, said mixture flowing as a continuous stream towards the outlet zone and said filler being capable of coagulating the elastomer latex,
c. the coagulum obtained previously is recovered at the outlet of the reactor in the form of a continuous stream and it is dried in order to recover the masterbatch.

16. A process according to claim 9, which additionally comprises the following steps:
adding, during a first “non-productive” stage, to the first masterbatch, the functional diene elastomer and the silica, by kneading thermomechanically until a maximum temperature of between 130° C. and 200° C. is reached,
cooling the combined mixture to a temperature below 100° C.,
subsequently incorporating a crosslinking system,
kneading everything up to a maximum temperature below 120° C.

17. A tire tread which comprises a rubber composition defined according to claim 1 or capable of being obtained by the process defined according to the following steps:
a. a first masterbatch comprising the natural rubber and the carbon black dispersed with a Z value greater than or equal to 90 is prepared,
b. the silica and the functional diene elastomer are added to the first masterbatch,
c. the combined mixture is mixed by thermomechanical kneading.

18. A tire which comprises a rubber composition defined according to claim 1 or capable of being obtained by the process defined according to the following steps:
a. a first masterbatch comprising the natural rubber and the carbon black dispersed with a Z value greater than or equal to 90 is prepared,
b. the silica and the functional diene elastomer are added to the first masterbatch,
c. the combined mixture is mixed by thermomechanical kneading.

19. A tire according to claim 18, intended to be fitted to vehicles bearing heavy loads and running on off-road surfaces.

20. A tire according to claim 18, wherein the composition is in its tread.
